(19) United States
(12) Patent Application Publication
(10) Pub. No.: US 2010/0227265 A1
(43) Pub. Date: Sep. 9, 2010

(54) ELECTROPHOTOGRAPHIC TONER

(76) Inventors: Mitsuyo MATSUMOTO, Osaka (JP); Chiyoshi Nozaki, Otsu-shi (JP); Atsushi Yamamoto, Kawanishi-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/717,399

(22) Filed: Mar. 4, 2010

(30) Foreign Application Priority Data
Mar. 5, 2009 (JP) 2009-052446

(51) Int. Cl. G03G 13/20; G03G 9/08; G03G 15/08

(52) U.S. Cl. 430/105; 399/265; 430/124.1

(57) ABSTRACT

A colorless transparent toner including a binder resin and a layered inorganic mineral, wherein the layered inorganic mineral is an organic modified layered inorganic mineral, in which at least part of ions present between layers are modified with an organic ion.

### BACKGROUND OF THE INVENTION

1. Field of the Invention

The present invention relates to a toner for developing a latent electrostatic image for use in a copier or a printer utilizing electrophotography, and an image forming apparatus using the toner.

2. Description of the Related Art

In electrophotographic image formation, it is demanded to enlarge color reproduction range so as to form a pictorial image. By the use of a color toner containing a dye instead of a pigment, it has been attempted to secure color reproducibility.

Moreover, to adjust chroma and gloss, a color toner and a transparent toner have been used in combination, wherein the transparent toner is superimposed on the color toner.

Japanese Patent Application Laid-Open (JP-A) No. 2004-20851 proposes the use of a transparent toner in which the temperature at which the viscosity becomes 10³ Pa·s is 80° C. to 130° C., and a color toner having a viscosity close to that of the transparent toner. JP-A No. 2006-209090 proposes the use of a toner, which is adjusted so that the storage elastic modulus of a white color toner or transparent toner at an achieving temperature in a fixing nip upon fixing is higher than the storage elastic modulus of each color toner at an achieving temperature in the fixing nip upon fixing. Japanese Patent (JP-B) No. 3526629 proposes the use of a color toner and a colorless adhesive toner having a glass transition temperature lower than that of the color toner.

These methods can add gloss to an image, but there is a problem that the weather resistance of the image was poor, even though the image is overcoated with a transparent toner.

### BRIEF SUMMARY OF THE INVENTION

An object of the present invention is to provide a toner and a toner kit, which have a wide color reproduction range, can adjust chroma and gloss, and can form a pictorial image, and is excellent in weather resistance and gas barrier property, and an image forming method and an image forming apparatus using the toner or the toner kit.

Means for solving the problem is as follows:

<1> A colorless transparent toner including a binder resin and a layered inorganic mineral, wherein the layered inorganic mineral is an organic modified layered inorganic mineral, in which at least part of ions present between layers are modified with an organic ion.
<2> The colorless transparent toner according to <1>, wherein the amount of the layered inorganic mineral is 0.01% by mass to 20% by mass.
<3> A toner kit including a color toner and the colorless transparent toner according to any one of <1> and <2>, wherein the color toner contains a binder resin and a colorant.
<4> The toner kit according to <3>, wherein the colorant of the color toner is a dye.
<5> Developing units each including a developer container for containing a developer, and a developer supply member configured to supply the developer from the developer container to a surface of a developer bearing member, and the developer bearing member configured to bear the supplied developer, wherein at least one of the developing units contains the developer containing the color toner, and at least one of the developing units contains the developer containing the colorless transparent toner, wherein the toner kit according to any one of <3> and <4> is used as the color toner and the colorless transparent toner.
<6> An image forming apparatus including a plurality of toner image forming units configured to form an image of a color toner and an image of a colorless transparent toner on a recording medium; and a fixing unit configured to fix the toner images on the recording medium, wherein each of the toner image forming units includes a latent image bearing member, a charging unit configured to uniformly charge a surface of the latent image bearing member, an exposing unit configured to expose the charged surface of the latent image bearing member based on image data so as to form a latent electrostatic image thereon, a developing unit configured to develop the latent electrostatic image formed on the surface of the latent image bearing member with supplying a developer so as to form a visible image, and a transferring unit configured to transfer the visible image on the surface of the latent image bearing member to the recording medium, wherein the developing units according to <5> are used.
<7> An image forming method including forming an image of a color toner and an image of a colorless transparent toner on a recording medium using the toner kit according to any one of <3> and <4>, and fixing the toner images on the recording medium.

The present invention can provide a toner containing an organic modified layered inorganic mineral, which is modified with an organic ion, formed of a fine laminate in which layered clay crystals each having a thickness of approximately 1 nm are oriented in the same direction, so as to exhibit bypass effect, thereby increasing gas barrier property. In the case where a color toner contains a colorant having high discoloring property, such as a dye serving as a colorant, in the present invention, the color toner is overcoated with a colorless transparent toner so as to prevent the color toner from discoloration and to improve weather resistance, and to provide an image forming apparatus, which can form a printed matter having excellent weather resistance by using the toner while maintaining the color reproducibility of a pictorial image.

### BRIEF DESCRIPTION OF THE DRAWINGS

FIG. 1 shows a cross-sectional view of a main part of an image forming apparatus equipped with developing units and process cartridge units of an embodiment of the present invention.

FIG. 2 shows a cross-sectional view of an example of a developing unit and a process cartridge unit of an embodiment of the present invention.

### DETAILED DESCRIPTION OF THE INVENTION

In view of the above-mentioned problems, the present invention is aimed to provide a colorless transparent toner containing at least a binder resin and an organic modified layered inorganic mineral, in which a part of ions between layers are modified with an organic ion.

The colorless transparent toner means toner particles which do not contain a colorant (for example, a coloring pigment, a coloring dye, black carbon particles, a black magnetic powder, etc.) used for the purpose of coloring by means of light absorption or light scattering. The colorless transparent toner is generally colorless and transparent, but the toner may have a somewhat low transparency depending on the types and amounts of a fluidizer and a releasing agent contained in the toner. However, the colorless transparent toner is substantially colorless and transparent.

Hereinafter, components of the toner of the present invention will be described.

### <Modified Layered Inorganic Mineral>

The layered inorganic mineral is an inorganic mineral formed of multilayer each having a thickness of several nanometers, and has a crystal structure in which three layers consist of silica tetrahedral layer-alumina octahedral layer-silica tetrahedral layer, wherein a unit layer has a thickness of approximately 1 nm and a broadening of 0.1 μm to 1 μm in the form of an extremely thin plate. The layered inorganic mineral is formed of a fine laminate in which layered clay crystals each having a thickness of approximately 1 nm are oriented in the same direction, so as to exhibit bypass effect. Thus, the gas barrier property is increased.

The “modified” means introduction of an organic ion to an ion present between the layers. This is called intercalation in a broad sense.

The organic modified layered inorganic mineral is formed by modifying at least part of the ions present between the layers of the layered inorganic mineral with the organic ion.

As the layered inorganic mineral, a smectite group (e.g., montmorillonite, saponite), a kaolin group (e.g., kaolinite), magadiite, and kanemite can be used. The layered inorganic mineral is highly hydrophilic due to ions present between layers. When a layered inorganic mineral, which is not modified with an organic ion, is dispersed in an aqueous medium to granulate toner particles, the layered inorganic mineral transfers into the aqueous medium so that toner particles cannot be deformed. By modifying the layered inorganic mineral with the organic ion, toner particles are easily deformed in the granulation, the granulated product can be dispersed and formed into fine particles, and the particles can sufficiently exhibit charge regulation function. The amount of the organic-modified layered inorganic mineral in a toner material is preferably 0.01% by mass to 20% by mass, more preferably 0.5% by mass to 10% by mass, and even more preferably 4.5% by mass to 5.5% by mass. When the amount is 0.01% by mass or less, gas barrier property cannot be exhibited. When the amount is more than 20.0% by mass, density and chroma are decreased.

The layered inorganic mineral modified with the organic ion used in the present invention is preferably those having a smectite basic crystal structure modified with an organic cation.

A metallic anion can be introduced by replacing part of bivalent metal of the layered inorganic mineral with trivalent metal.

However, since the introduction of metallic anion increases hydrophilicity of the layered inorganic mineral, it is preferable to modify part of the metallic anion with an organic anion.

Examples of an organic ion modifier for use in modifying at least part of the ions present between the layers of the layered inorganic mineral include a quaternary alkyl ammonium salt, a phosphonium salt, and an imidazolium salt, with preference given to a quaternary alkyl ammonium salt. Examples of the quaternary alkyl ammonium salt include trimethylstearyl ammonium, dimethylstearylbenzyl ammonium, dimethyloctadecylammonium, and, oleyl bis(2-hydroxyethyl)methyl ammonium.

Examples of the organic ion modifier include a sulfate, sulfonate, carboxylate and phosphate, each having a branched, linear or cyclic alkyl (C1-C44), alkenyl (C1-C22), alkoxy (C8-C32), hydroxyalkyl (C2-C22), ethylene oxide, or propylene oxide. Of these, a carboxylate having an ethylene oxide skeleton is preferred.

The layered inorganic mineral, which is to be partly modified with the organic ion, may be appropriately selected. Examples thereof include montmorillonite, bentonite, hectolite, attapulgite, sepiolite, and mixtures thereof. It is preferable to use organic-modified montmorillonite and bentonite.

Examples of commercially available products of the layered inorganic mineral partly modified with the organic cation include a quaternium 18 bentonite such as BENTONE 3, BENTONE 38, and BENTONE 38V (all produced by Rheox Corp.) THIXOGEL VP (produced by United Catalyst Corp.), CLAYTON 34, CLAYTON 40 and CLAYTON XL (all produced by Southern Clay Products, Inc.); a stearalconium bentonite such as BENTONE 27 (produced by Rheox Corp.), THIXOGEL LG (produced by United Catalyst Corp.), CLAYTON AF, CLAYTON APA (all produced by Southern Clay Products, Inc.); a quaternium 18/benzalconium bentonite such as CLAYTON HT and CLAYTON PS (all produced by Southern Clay Products, Inc.). CLAYTON AF and CLAYTON APA are particularly preferable. As the layered inorganic mineral partly modified with an organic anion DHT-4A (produced by Kyowa Chemical Industry Co., Ltd.) modified with an organic anion represented by the following General Formula (1) is particularly preferable. Example of the compounds modified with the organic anion represented by General Formula (1) include HITENOL 330T (produced by Dai-ichi Kogyo Seiyaku Co., Ltd.).

R₁(OR₂)ₙOSO₃M General Formula (1)

In General Formula (1), R₁ represents an alkyl group having 13 carbon atoms, R₂ represents an alkylene group having 2 to 6 carbon atoms, n is an integer of 2 to 10, and M is a univalent metallic element.

A kneaded composite of the modified layered inorganic mineral and the binder resin, i.e. master batch can be produced by mixing and kneading the binder resin and the layered inorganic mineral modified with an organic ion under high shearing force. In this process, to enhance interaction between the modified layered inorganic mineral and the binder resin, an organic solvent is preferably added. Moreover, a so-called flushing method is preferably used in that a wet cake can be used as it is, and no drying is needed. In this flushing method, an aqueous paste containing the modified layered inorganic mineral and water is mixed and kneaded with a resin and an organic solvent, and the modified layered inorganic mineral is transfer to the resin to remove water and an organic solvent component. In the mixing and kneading, a high shearing dispersion device, such as a triple roll mill is preferably used.

In the kneaded composite of the modified layered inorganic mineral and the binder resin, i.e. master batch, the modified layered inorganic mineral preferably has a volume average particle diameter (Dv) of 0.1 μm to 0.5 μm. When the volume average particle diameter (Dv) is less than 0.1 μm, the gas barrier effect cannot be sufficiently obtained. When it is more than 0.5 μm, the modified layered inorganic mineral is poorly dispersed in the toner, and the gas barrier effect cannot be exhibited.

### <Binder Resin for Toner>

### (Binder Resin for Pulverized Toner)

The binder resin for toner including a first binder resin and a second binder resin can be used.

The first binder resin and the second binder resin are not particularly limited. Examples thereof include known binder resins in the field of full-color toner such as polyester resins, (meth)acrylic resins, a styrene-(meth)acrylic copolymer resin, epoxy resins, cyclic olefin resins (COC, e.g. TOPAS-COC, produced by Ticona). The polyester resins are preferably used as the first and second binder resins in terms of oilless fixation.

The polyester resins preferably used in the present invention may be those obtained by polycondensation of polyhydric alcohol component and polyvalent carboxylic acid component. Examples of dihydric alcohol component included in the polyvalent alcohol component include bisphenol A-alkylene oxide adducts such as polyoxypropylene (2,2)-2,2-bis (4-hydroxyphenyl) propane, polyoxypropylene (3,3)-2,2-bis (4-hydroxyphenyl) propane, polyoxypropylene (6)-2,2-bis (4-hydroxyphenyl) propane and polyoxyethylene (2,0)-2,2-bis (4-hydroxyphenyl) propane; ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polytetramethylene glycol, bisphenol A and hydrogenated bisphenol A. Examples of trihydric or more alcohol components include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethyrolethane, trimethyrolpropane, and 1,3,5-trihydroxymethylbenzene.

Furthermore, examples of bivalent carboxylic acid component of polyvalent carboxylic acid components include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, n-dodecenyl succinic acid, isododecenyl succinic acid, n-dodecyl succinic acid, isododecyl succinic acid, n-octenyl succinic acid, isooctenyl succinic acid, n-octyl succinic acid, isooctyl succinic acid and anhydrides thereof or lower alkylesters thereof.

Examples of trivalent or more carboxylic acid components include 1,2,4-benzenetricarboxylic acid (trimellitic acid), 1,2,5-benzentricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra (methylenecarboxyl) methane, 1,2,7,8-octanetetracarboxylic acid, pyromellitic acid, Enpol trimer acid and anhydrides thereof or lower alkylesters thereof.

Furthermore, a resin (hereinafter may be referred to as “a vinyl polyester resin”) obtained by performing condensation polymerization for obtaining a polyester resin and radical polymerization for obtaining a vinyl resin concurrently in one container using a mixture of a basic monomer of polyester resin, basic monomer of vinyl resin and a monomer which reacts with the basic monomers of both resins may be also preferably used as a polyester resin. Meanwhile, the monomer which reacts with basic monomers of both resins is, that is, a monomer which can be used for both reactions of condensation polymerization and radical polymerization. In other words, it is a monomer having a carboxyl group which is reactable in condensation polymerization and a vinyl group which is reactable in radical polymerization and examples of such monomer include fumaric acid, maleic acid, acrylic acid and methacrylic acid.

Examples of the basic monomers of the polyester resin include above-mentioned polyvalent alcohol components and polyvalent carboxylic acid components. Examples of the basic monomers of the vinyl resin include styrene or styrene derivatives including styrene, o-methylstyrene, m-methylstyrene, p-methylstyrene, α-methylstyrene, p-ethylstyrene, 2,4-dimethylstyrene, p-tert-butylstyrene and p-chlorostyrene; ethylene unsaturated monoolefins including ethylene, propylene, butylene and isobutylene; methacrylic acid alkylesters such as methyl methacrylate, n-propyl methacrylate, isopropyl methacrylate, n-butyl methacrylate, isobutyl methacrylate, t-butyl methacrylate, n-pentyl methacrylate, isopentyl methacrylate, neopentyl methacrylate, 3-(methyl)butyl methacrylate, hexyl methacrylate, octyl methacrylate, nonyl methacrylate, decyl methacrylate, undecyl methacrylate and dodecyl methacrylate; acrylic acid alkylesters such as methyl acrylate, n-propyl acrylate, isopropyl acrylate, n-butyl acrylate, isobutyl acrylate, t-butyl acrylate, n-pentyl acrylate, isopentyl acrylate, neopentyl acrylate, 3-(methyl)butyl acrylate, hexyl acrylate, octyl acrylate, nonyl acrylate, decyl acrylate, undecyl acrylate and dodecyl acrylate; and unsaturated carboxylic acids such as acrylic acid, methacrylic acid, itaconic acid and maleic acid; acrylonitrile, maleic acid ester, itaconic acid ester, vinyl chloride, vinyl acetate, benzoic acid vinyl, vinyl methyl ethyl ketone, vinyl hexyl ketone, vinyl methyl ether, vinyl ethyl ether and vinyl isobutyl ether. Examples of polymerization initiator which is used for initiating polymerization of the basic monomers of the vinyl resin include azo-based or diazo-based polymerization initiators such as 2,2′-azobis (2,4-dimethylvaleronitrile), 2,2′-azobisisobutyronitrile, 1,1′-azobis (cyclohexane-1-carbonitrile), 2,2′-azobis-4-methoxy-2,4-dimethylvaleronitrile and peroxide-based polymerization initiators such as benzoyl peroxide, dicumyl peroxide, methyl ethyl ketone peroxide, isopropyl peroxycarbonate and lauroyl peroxide.

Various polyester resins as described above are preferably used as the first binder resin and the second binder resin. Of these, the first binder resin and the second binder resin described below is more preferably used, in terms of further improvement of separation properties and offset resistance as a toner for oilless fixation.

As the first binder resin, a polyester resin obtained by condensation polymerization of above-mentioned polyvalent alcohol components and polyvalent carboxylic acid components, particularly a polyester resin obtained by using bisphenol A-alkylene oxide adduct as the polyvalent alcohol component and terephthalic acid and fumaric acid as the polyvalent carboxylic components is preferably used.

As the second binder resin, a vinyl polyester, particularly a vinyl polyester resin obtained by using bisphenol A-alkylene oxide adduct, terephthalic acid, trimellitic acid and succinic acid as the basic monomers of the polyester resin, using styrene and butylacrylate as the basic monomers of vinyl resin, and using fumaric acid as a monomer which is reactable in both reactions, is preferably used.

In the present invention, as described above, a hydrocarbon-based releasing agent is internally added upon synthesis of the first binder resin. To previously internally add the hydrocarbon-based releasing agent to the first binder resin, the first binder resin may be synthesized with adding the hydrocarbon-based releasing agent in the monomers for synthesizing the first binder resin. For example, the polycondensation may be performed in a state that the hydrocarbon-based releasing agent has been added to an acid monomer or alcohol monomer which constitutes the polyester-based resin as the first binder resin. When the first binder resin is a vinyl polyester resin, a hydrocarbon-based releasing agent is first added to the basic monomer for the polyester resin, and then polycondensation and radical polymerization may be performed by adding dropwise the basic monomer for the vinyl resin to the monomer while stirring and heating the monomers.

### (Binder Resin for Polymerization Toner)

A binder resin for polymerization toner (A) used in the present invention is not particularly limited, and may be appropriately selected according to the purpose. Preferred examples thereof include a styrene-acrylic resin, and a polyester resin.

In the present invention, a polyester resin is particularly preferably used. The polyester resin used in the present invention is not limited, and any polyester resin may be used. A several types of polyester resins may be used in combination. The polyester resin may be, for example, a polycondensation product of polyol (1) and polycarboxylic acid (2) as described below.

### (Polyol)

Examples of the polyol (1) include alkylene glycols (such as ethylene glycol, 1,2-propylene glycol, 1,3-propylene glycol, 1,4-butanediol, and 1,6-hexanediol); alkylene ether glycols (such as diethylene glycol, triethylene glycol, dipropylene glycol, polyethylene glycol, polypropylene glycol, and polytetramethylene ether glycol); alicyclic diols (such as 1,4-cyclohexane dimethanol and hydrogenated bisphenol A); bisphenols (for example, bisphenol A, bisphenol F, bisphenol S, 4,4′-dihydroxyphenyls such as 3,3′-difluoro-4,4′-dihydroxybiphenyl); bis(hydroxyphenyl)alkanes such as bis(3-fluoro-4-hydroxyphenyl)methane, 1-phenyl-1,1-bis(3-fluoro-4-hydroxyphenyl)ethane, 2,2-bis(3-fluoro-4-hydroxyphenyl)propane, 2,2-bis(3,5-difluoro-4-hydroxyphenyl)propane (also known as tetrafluorobisphenol A), 2,2-bis(3-hydroxyphenyl)-1,1,1,3,3,3-hexafluoropropane); bis(4-hydroxyphenyl)ethers such as bis(3-fluoro-4-hydroxyphenyl)ether); adducts of the above-mentioned alicyclic diols with an alkylene oxide (such as ethylene oxide, propylene oxide, or butylene oxide); and adducts of the above-mentioned bisphenols with an alkylene oxide (such as ethylene oxide, propylene oxide, or butylene oxide).

Of these, alkylene glycols having 2 to 12 carbon atoms and adducts of a bisphenol with an alkylene oxide are preferable. Adducts of a bisphenol with an alkylene oxide, or a mixture of such an adduct and an alkylene glycol having 2 to 12 carbon atoms is particularly preferable.

Other examples include trihydric to octahydric or higher polyhydric aliphatic alcohols (such as glycerol, trimethylolethane, trimethylolpropane, pentaerythritol, and sorbitol); trihydric and higher phenols (such as trisphenol PA, phenol novolac, and cresol novolac); and adducts of the above-mentioned trihydric or higher polyphenols mentioned with an alkylene oxide.

These polyols can be used singly or in combination, and are not limited to those listed above.

### (Polycarboxylic Acid)

Examples of the polycarboxylic acid (2) include alkylene dicarboxylic acids (such as succinic acid, adipic acid, and sebacic acid), alkenylene dicarboxylic acids (such as maleic acid and fumaric acid), and aromatic dicarboxylic acids (such as phthalic acid, isophthalic acid, terephthalic acid, naphthalene dicarboxylic acid, 3-fluoroisophthalic acid, 2-fluoroisophthalic acid, 2-fluoroterephthalic acid, 2,4,5,6-tetrafluoroisophthalic acid, 2,3,5,6-tetrafluoroterephthalic acid, 5-trifluoromethylisophthalic acid, 2,2-bis(4-carboxyphenyl)hexafluoropropane, 2,2-bis(3-carboxyphenyl)hexafluoropropane, 2,2′-bis(trifluoromethyl)-4,4′-biphenyldicarboxylic acid, 3,3′-bis(trifluoromethyl)-4,4′-biphenyldicarboxylic acid, 2,2′-bis(trifluoromethyl)-3,3′-biphenyldicarboxylic acid, and hexafluoroisopropylidene diphthalic anhydride).

Of these, an alkenylene dicarboxylic acid having 4 to 20 carbon atoms, and an aromatic dicarboxylic acid having 8 to 20 carbon atoms are preferred. An aromatic polycarboxylic acid having 9 to 20 carbon atoms (such as trimellitic acid or pyromellitic acid), or an acid anhydride or a lower alkyl ester (such as a methyl ester, ethyl ester, or isopropyl ester) of the listed above, can be used as a trihydric or higher polycarboxylic acid to react with the polyol (1). The above polycarboxylic acids can be used singly or in combination, and are not limited to those listed above.

### (Ratio of Polyol to Polycarboxylic Acid)

The ratio of the polyol (1) to the polycarboxylic acid (2), as the equivalence ratio OH/COOH of hydroxyl groups (OH) to carboxyl groups (COOH), is usually from 2/1 to 1/1, preferably from 1.5/1 to 1/1, and more preferably from 1.3/1 to 1.02/1.

### (Molecular Mass of Polyester Resin)

The peak molecular mass is preferably 1,000 to 30,000, more preferably 1,500 to 10,000, even more preferably 2,000 to 8,000. The molecular mass less than 1,000 cannot ensure heat resistance and storage stability. The molecular mass exceeding 30,000 degrades low temperature fixability.

### <Modified Polyester Resin>

The binder resin (A) used in the present invention may contain a modified polyester resin having an urethane and/or urea group in order to regulate a viscoelasticity for offset prevention. Amount of the modified polyester resin having an urethane and/or urea group in the binder resin (A) is preferably 20% by mass or less, more preferably 15% by mass or less, even more preferably 10% by mass or less. An amount exceeding 20% by mass degrades low temperature fixability. The modified polyester resin having an urethane and/or urea group may be mixed directly in the binder resin (A). In terms of production efficiency, it is preferred that the modified polyester resin having an isocyanate group at the terminal thereof and having a relatively low molecular mass (hereinafter, also referred to as prepolymer) and amines reactive with the prepolymer be mixed in the binder resin (A), and that the mixture be subjected to chain elongation and/or crosslinking reaction during and/or after granulation, to thereby obtain the modified polyester resin having an urethane and/or urea group. When preparing toner particles by the granulation, the presence of modified polyester resin facilitates the incorporation of a modified polyester resin having relatively high molecular mass for adjusting the viscoelasticity into the core portions of toner particles.

### (Prepolymer)

The prepolymer having an isocyanate group is preferably obtained by reacting the polyester having an active hydrogen group, which is a polycondensation product of the polyol (1) and the polycarboxylic acid (2), with polyisocyanate (3). Examples of the active hydrogen group contained in the polyester include a hydroxy group (alcoholic hydroxy group and phenolic hydroxy group), amino group, carboxyl group, and mercapto group. Of these, an alcoholic hydroxy group is preferable.

### (Polyisocyanate)

Examples of the polyisocyanate (3) include aliphatic polyisocyanates (such as tetramethylene diisocyanate, hexamethylene diisocyanate and 2,6-diisocyanate methylcaproate); alicyclic polyisocyanates (such as isophorone diisocyanate and cyclohexylmethane diisocyanate); aromatic diisocyanates (such as tolylene diisocyanate and diphenylmethane diisocyanate); aromatic aliphatic diisocyanates (such as α,α,α′,α′-tetramethyl xylylene diisocyanate); isocyanurates; and blocked polyisocyanates in which the above polyisocyanates are blocked with a phenol derivative, oxime, or caprolactam. These can be used singly or in combination.

### (Ratio of Isocyanate Groups to Hydroxyl Groups)

The ratio of the polyisocyanate (3), as an equivalent ratio NCO/OH of isocyanate groups (NCO) to hydroxyl groups (OH) of the polyester having hydroxyl groups, is usually from 5/1 to 1/1, preferably from 4/1 to 1.2/1, and more preferably from 2.5/1 to 1.5/1. When the ratio NCO/OH is more than 5, the low temperature fixability of the toner degrades. When the ratio is less than 1, the urea content in the modified polyester is so low that hot offset resistance is poor. The amount in which the constituent components of the polyisocyanate (3) are contained in the prepolymer (A) having an isocyanate group at its terminal is usually 0.5% by mass to 40% by mass, preferably 1% by mass to 30% by mass, and more preferably from 2% by mass to 20% by mass. When the amount is less than 0.5% by mass, offset resistance will degrade. When the amount is more than 40% by mass, low temperature fixability will degrade.

### (Number of Isocyanate Groups in Prepolymer)

The number of isocyanate groups included per molecule of the prepolymer (A) having an isocyanate group is usually 1 or more, preferably from 1.5 to 3 on average, and more preferably 1.8 to 2.5 on average. When the number is less than 1 per molecule, the molecular mass of the modified polyester will be lower after crosslinking and/or elongation, and offset resistance will degrade.

### (Chain Elongation Agent and Crosslinking Agent)

An amine can be used as a chain elongation agent or crosslinking agent. Examples of the amine (B) include diamines (B1), trivalent or higher polyamines (B2), amino alcohols (B3), amino mercaptans (B4), amino acids (B5), and blocked amines (B6) in which an amino group in B1 to B5 are blocked.

Examples of the diamines (B1) include aromatic diamines (such as phenylenediamine, diethyltoluenediamine, 4,4′-diaminodiphenylmethane, tetrafluoro-p-xylylenediamine, and tetrafluoro-p-phenylenediamine), alicyclic diamines (such as 4,4′-diamino-3,3′-dimethyldicyclohexylmethane, diaminocyclohexane, and isophoronediamine), and aliphatic diamines (such as ethylenediamine, tetramethylenediamine, hexamethylenediamine, dodecafluorohexylenediamine and tetracosafluorododecylene diamine).

Examples of the trivalent or higher polyamines (B2) include diethylenetriamine and triethylenetetramine.

Examples of the amino alcohols (B3) include ethanolamine and hydroxyethyl aniline.

Examples of the amino mercaptans (B4) include aminoethyl mercaptan and aminopropyl mercaptan.

Examples of the amino acids (B5) include aminopropionic acid and aminocaproic acid.

Examples of the blocked amines (B6) in which the amino group in (B1) to (B5) are blocked include ketimine compounds and oxazoline compounds obtained from one of the above amines (B1) to (B5) and ketones (such as acetone, methyl ethyl ketone, or methyl isobutyl ketone).

### (Stopping Agent)

The molecular mass of the modified polyester resin upon completion of the reaction can be adjusted as necessary using a reaction stopping agent for the chain elongation and/or crosslinking. Examples of the stopping agent include monoamines (such as diethylamine, dibutylamine, butylamine, and laurylamine) and blocked amines (ketimine compounds) obtained by blocking the above monoamines.

### (Ratio of Amino Groups to Isocyanate Groups)

The ratio of the amines (B), as an equivalent ratio [NCO]/[NHx] of isocyanate groups [NCO] in the prepolymer (A) having an isocyanate group to amino groups [NHx] in the amines (B), is usually from 1/2 to 2/1, preferably from 1.5/1 to 1/1.5, and more preferably from 1.2/1 to 1/1.2. When [NCO]/[NHx] is more than 2 or less than ½, the molecular mass of urea-modified polyester is so low that hot offset resistance degrades.

### <Colorant>

As a colorant used in the present invention, any known dyes and pigments can be used. Examples of pigment colorants include carbon black, copper oxide, manganese dioxide, aniline black, activate carbon, nonmagnetic ferrite, magnetic ferrite, magnetite, chrome yellow, zinc yellow, cadmium yellow, yellow oxide, mineral fast yellow, nickel titanium yellow, navel's yellow, naphthol yellow S, Hansa yellow G, Hansa yellow 10G, benzidine yellow G, benzidine yellow GR, quinoline yellow lake, permanent yellow NCG, tartrazine lake, red chrome yellow, molybdate orange, permanent orange GTR, pyrazolone orange, vulcan orange, indanthrene brilliant orange RK, benzidine orange G, indanthrene brilliant orange GK, red oxide, cadmium red, red lead, vermillion, cadmium, permanent red 4R, lithol red, pyrazolone red, Watchung red, calcium salt, lake red C, lake red D, brilliant carmine 6B, eosine lake, rhodamine lake B, alizalin lake, brilliant carmine 3B, manganese violet, fast violet R, methyl violet lake, Prussian blue, cobalt blue, alkali blue lake, Victoria blue lake, phthalocyanine blue, metal-free phthalocyanine blue, partially chlorinated phthalocyanine blue, fast sky blue, and indanthrene blue BC.

Examples of dye colorants include Solvent Yellow 9, 17, 24, 31, 35, 58, 93, 100, 102, 103, 105, 112, 162, 163, Disperse Yellow 3, 42, 64, 82, 160, 201, C.I. Disperse Violet 26, 31, C.I. Disperse Red 4, 5, 60, 91, C.I. Solvent Red 8, 49, 52, Neopen Magenta 525 (produced by BASF), Macrolex RED H (produced by Bayer AG), Solvent Blue 36, 63, 64, 67, 68, 70, 97, Neopen Cyan 742 (produced by BASF), Macrolex Blue 3R (produced by Bayer AG).

The amount of the colorant is generally 1% by mass to 15% by mass, and preferably 3% by mass to 10% by mass, relative to the toner.

### <Producing Colorant Master Batch>

The colorant used in the present invention can also be compounded with a resin and used as a master batch. Examples of the binder resin kneaded along with the master batch or used in the production of the master batch include the modified and unmodified polyester resins listed above, and styrene and substituted styrene polymers (such as polystyrenes, poly-p-chlorostyrenes, and polyvinyltoluenes), styrene copolymers (such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers, and styrene-maleic acid ester copolymers), polymethyl methacrylates, polybutyl methacrylates, polyvinyl chlorides, polyvinyl acetates, polyethylenes, polypropylenes, polyesters, epoxy resins, epoxy polyol resins, polyurethanes, polyamides, polyvinyl butyrals, polyacrylic acid resins, rosins, modified rosins, terpene resins, aliphatic or alicyclic hydrocarbon resins, aromatic petroleum resins, chlorinated paraffins, and paraffin waxes. These resins can be used singly or in mixtures.

### <Method for Producing Master Batch>

A master batch can be obtained by mixing the master batch resin and the colorant and kneading the mixture under a high shearing force. An organic solvent can be used to increase the interaction between the colorant and the resin. What is known as a flushing method is a method, in which an aqueous paste including a colorant and water is mixed and kneaded with a resin and an organic solvent so that the colorant migrates to the resin side, and the organic solvent and water are removed. The flushing method is preferably used, because a wet cake of the colorant may be directly used without drying the cake. Upon mixing and kneading the components, it is preferable to use a high-shear dispersing device such as a triple roll mill.

### <Releasing Agent>

As a releasing agent used in the present invention, any known releasing agent can be used. Examples thereof include polyolefin waxes (such as polyethylene wax and polypropylene wax); long chain hydrocarbons (such as paraffin wax and Sasolwax); and carbonyl group-containing waxes. Examples of the carbonyl group-containing wax include polyalkanoic acid esters (such as carnauba wax, montan wax, trimethylolpropane tribehenate, pentaerythritol tetrabehenate, pentaerythritol diacetatedibehenate, glycerine tribehenate, 1,18-octadecanedioldistearate); polyalkanolesters (such as tristearyl trimellitate, distearyl malleate); polyalkanoic acid amides (such as ethylenediamine dibehenylamide); polyalkylamides (such as trimellitic acid tristearylamide); and dialkyl ketones (such as distearyl ketone). Of these carbonyl group-containing waxes, preferable is polyalkanoic acid esters.

An amount of wax in the toner is preferably 5% by mass to 15% by mass relative to 100% by mass of the resin components. When the amount of wax in the total amount of the toner is less than 5% by mass, wax cannot achieve the releasing effect, and the allowance to prevent offset may be insufficient. When the amount is more than 15% by mass, since wax melts at a low temperature and so is susceptible to thermal energy and mechanical energy, wax tends to ooze out of the toner when stirring in a developing part, and the oozed wax adheres to a toner controlling member or a latent electrostatic image bearing member, resulting in the occurrence of the image noise. A peak thermal absorption of the wax measured by using a differential scanning calorimeter (DSC) at an elevated temperature is in the rage of 65° C. to 115° C., where the low temperature fixation of the toner is possible. When the melting point is lower than 65° C., the flowability degrades. When it is higher than 115° C., fixability degrades.

### <Charge Control Agent>

The toner of the present invention may contain if necessary a charge control agent. Any known charge control agent may be used for the toner of the present invention. Examples thereof include nigrosine dye, triphenylmethane dye, chromium-containing metal complex dye, molybdic acid chelate pigment, rhodamine dye, alkoxy amine, quaternary ammonium salt (including fluorine-modified quaternary ammonium salt), alkylamide, elemental phosphorus or compound thereof, elemental tungsten or compound thereof, fluorine activator, metal salicylate and metal salt of salicylic derivative. Specific examples include Bontron 03 of a nigrosine dye, Bontron P-51 of a quaternary ammonium salt, Bontron S-34 of a metal-containing azo dye, E-82 of oxynaphthoic acid metal complex, E-84 of salicylic acid metal complex and E-89 of a phenol condensate (produced by Orient Chemical Industries, Ltd.); TP-302 and TP-415 of molybdic complex of quaternary ammonium salt (produced by Hodogaya Chemical Co., Ltd.); Copy Charge PSY VP2038 of a quaternary ammonium salt, Copy Blue PR of a triphenylmethane derivative and Copy Charge NEG VP2036 and NX VP434 of quaternary ammonium salt (produced by Hoechst Co.); LRA-901 and LR-147 of a boron complex (produced by Japan Carlit Co., Ltd); copper phthalocyanine, perylene, quinacridone, azo pigment and polymer compound having a functional group such as a sulfonate group, carboxyl group and quaternary ammonium salt.

### <External Additive>

### (Inorganic Fine Particles)

Inorganic fine particles may be used preferably as an external additive for assisting the flowability, developing property, and chargeability of the colorant particles obtained in the present invention. The primary particle diameter of these inorganic fine particles is preferably 5 nm to 2 μm, and particularly preferably 5 nm to 500 nm. The specific surface area as measured by BET method is preferably 20 m²/g to 500 m²/g. The proportion in which these inorganic fine particles are used is preferably 0.01% by mass to 5% by mass, and particularly preferably 0.01% by mass to 2.0% by mass, with respect to the toner. Specific examples of the inorganic fine particles include silica, alumina, titanium oxide, barium titanate, magnesium titanate, calcium titanate, strontium titanate, zinc oxide, tin oxide, quartz sand, clay, mica, wollastonite, diatomaceous earth, chromium oxide, cerium oxide, red iron oxide, antimony trioxide, magnesium oxide, composite oxides (such as silicon oxide/magnesium oxide, silicon oxide/aluminum oxide), zirconium oxide, barium sulfate, barium carbonate, calcium carbonate, silicon carbide, and silicon nitride.

### (Polymer Fine Particles)

In addition, polymer fine particles may be used, such as methacrylic ester or acrylic ester copolymers or polystyrene obtained by soap-free emulsion polymerization, suspension polymerization or dispersion polymerization; polycondensates of silicone, benzoguanamine, nylon, and the like; and polymer particles produced from thermosetting resins.

(Surface Treatment with External Additive)

Such fluidizers can be surface treated to make them hydrophobic, which prevents the flowability and charge properties from degradation even under high humidity. Examples of the surface treatment include silane coupling agents, silylation agents, silane coupling agents having a fluoroalkyl group, organic titanate-based coupling agents, aluminum-based coupling agents, silicone oils, and modified silicone oils.

### (Cleaning Improver)

A cleaning improver may be used to remove any developer remaining on a latent electrostatic image bearing member, or a primary transfer medium after transferring. Examples thereof include fatty acid metal slats such as zinc stearate, calcium stearate, stearic acid; and polymer fine particles produced by a soap-free emulsion polymerization method or the like, such as polymethyl methacrylate fine particles and polystyrene fine particles. The polymer fine particles preferably have a relatively narrow particle size distribution and a volume average particle size of 0.01 μm to 1 μm.

### <Method of Producing Toner>

When a toner material is emulsified or dispersed in an aqueous medium using a liquid containing the toner material, the liquid containing the toner material is preferably dispersed in the aqueous medium while stirring.

For dispersion, any known dispersing machines can be appropriately used. Examples thereof include a low-shear dispersing machine, a high-shear dispersing machine, friction dispersing machine, a high-pressure jet dispersing machine, and an ultrasonic dispersing machine. A high-shear dispersing machine is preferable, as it can adjust the particle size of the dispersion (oil droplet) to between 2 μm and 20 μm.

When a high-shear dispersing machine is used, the conditions such as a rotational speed, a dispersion time, a temperature during dispersion and the like are not particularly limited, and may be appropriately selected according to the purpose. The rotational speed is preferably 1,000 rpm to 30,000 rpm, and more preferably 5,000 rpm to 20,000 rpm. The dispersion time is preferably 0.1 min to 5 min in the case of a batch method. The temperature during dispersion is preferably 0° C. to 150° C., and more preferably 40° C. to 98° C., under pressure. Meanwhile, in general, the dispersion can be easily performed when the temperature during dispersion is high.

A method for forming toner base particles can be appropriately selected from known methods. Examples thereof include a method for forming toner base particles using suspension polymerization, emulsion polymerization aggregation, dissolution suspension, or the like, and a method for forming toner base particles while an adhesive base material is produced. Of these, the method for forming toner base particles while the adhesive base material is produced is preferred. Here, the adhesive base material is a base material having adhesiveness with a recording medium such as paper.

The method for forming toner base particles while the adhesive base material is produced is a method in which a toner material contains an active hydrogen group-containing compound, and a polymer having reactivity with the active hydrogen group, and in an aqueous medium, the active hydrogen group-containing compound is reacted with the polymer having reactivity with the active hydrogen group so as to produce the adhesive base material, during the formation of toner base particles.

The adhesive base material may further contain other known binder resins.

The toner obtained by the above-described method preferably contains the colorant, and may further contains other components appropriately selected as necessary, such as a releasing agent, a charge controlling agent, and the like.

The adhesive base material preferably has a mass average molecular mass of 3,000 or more, more preferably 5,000 to 1,000,000 and particularly preferably 7,000 to 500,000. When the mass average molecular mass is less than 3,000, hot offset resistance may be degraded.

The toner of the present invention is preferably produced by the following method, but not limited thereto.

The method for producing the toner of the present invention includes at least dissolving or dispersing a binder resin having an aromatic group-containing polyester skeleton, a highly-polar resin, a colorant, and a releasing agent in an organic solvent, and thereafter dispersing the solution or dispersion liquid into an aqueous medium, so as to granulate the toner particles.

Hereinafter, the method for producing the toner will be specifically explained.

### <Granulation Process>

### (Organic Solvent)

As the organic solvent to dissolve or disperse a binder resin having an aromatic group-containing polyester skeleton, a colorant, and a releasing agent, it is preferable to use any of those recited in “POLYMER HANDBOOK,” 4th edition, WILEY-INTERSCIENCE, vol. 2, sec VII, having a Hansen solubility parameter of 19.5 or less. Preferably, the organic solvent is a volatile material having a boiling point less than 100° C., since the solvent removal can be easily performed in a later step. Examples of the organic solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These solvents may be used singly or in combination. Of these, preferred are esters such as methyl acetate and ethyl acetate; aromatic solvents such as toluene and xylene; halogenated hydrocarbons such as 1,2-dichloroethane, chloroform and carbon tetrachloride. The polyester resin, colorant and releasing agent may be dissolved or dispersed in an organic solvent simultaneously, but generally each of the polyester resin, colorant and releasing agent is dissolved or dispersed individually. When each of them is dissolved or dispersed individually, the organic solvents to be used may be the same or different, but are preferably the same because of easiness of solvent removal at a later stage.

(Dissolution or Dispersion of Binder Resin having an Aromatic Group-Containing Polyester Skeleton)

As for the solution or dispersion liquid of the binder resin having an aromatic group-containing polyester skeleton, a resin concentration is preferably 40% by mass to 80% by mass. When the resin concentration is too high, it is difficult to perform the dissolution or the dispersion, and a viscosity becomes so high that the solution or dispersion liquid is difficult to handle. When the resin concentration is too low, the amount of the toner to be produced becomes small. When a binder resin having an aromatic group-containing polyester skeleton is mixed with the modified polyester resin having an isocyanate group at the terminal, they may be mixed in the same solution or dispersion liquid, or the solution or dispersion liquid may be prepared separately, but in view of each solubility and viscosity, it is preferable to prepare the solution or dispersion liquid separately.

### (Dissolution or Dispersion of Colorant)

The colorant may be dissolved or dispersed solely, or may be mixed in the solution or dispersion liquid of the polyester resin. If necessary, a dispersion aid or a polyester resin may be added in the colorant, or the master batch may be used.

### (Dissolution or Dispersion of the Releasing Agent)

In the case where wax is dissolved or dispersed as the releasing agent, when the organic solvent which does not dissolve the wax is used, the wax is used as a dispersion liquid, and the dispersion liquid is made by general methods. That is, the organic solvent and the wax are mixed and dispersed using a dispersing machine such as bead mill. When the organic solvent and the wax are mixed, then the mixture is heated up to a melting point of the wax, subsequently cooled down with stirring and then dispersed by a dispersing machine such as bead mill, a dispersion time period can be shortened. A mixture of multiple waxes may be used, and the dispersion aid or the polyester resin may be added in the releasing agent.

### (Dispersion of Modified Layered Inorganic Mineral)

The modified layered inorganic mineral can be mixed in a liquid in which the binder resin is dissolved or dispersed.

Moreover, the modified layered inorganic mineral and the binder resin may be mixed, and melted and kneaded, and followed by pulverized, and then used as a kneaded composite of the modified layered inorganic mineral and the binder resin (master batch).

### (Aqueous Medium)

Water alone can be used as an aqueous medium, but a solvent miscible with water can also be used in combination. Further, the above-mentioned organic solvent used for the oil phase and having a Hansen solubility parameter of 19.5 or less can also be added, and preferably the added amount is near the saturation amount in water, as this will improve the emulsification or dispersion stability of the oil phase. Examples of the miscible solvents include alcohols (such as methanol, isopropanol and ethylene glycol), dimethylformamide, tetrahydrofuran, cellosolves (such as methyl cellosolve), and lower ketones (such as acetone and methyl ethyl ketone). The amount in which the aqueous medium is used is usually 50 parts by mass to 2,000 parts by mass, and preferably 100 parts by mass to 1,000 parts by mass, relative to 100 parts by mass of a toner composition. When the amount is less than 50 parts by mass, the toner composition will not be dispersed well, and toner particles having the specified particle diameter will not be obtained. Use of the amount more than 2,000 parts by mass is economically disadvantageous.

### (Inorganic Dispersing Agent and Organic Resin Fine Particle)

When a dissolved matter or a dispersed matter of the toner composition is dispersed in the aqueous medium, it is preferable that an inorganic dispersing agent or organic resin fine particles be dispersed beforehand so that the toner particles have a sharp particle size distribution and the dispersion is stably performed. Examples of the inorganic dispersing agent include tricalcium phosphate, calcium carbonate, titanium oxide, colloidal silica, and hydroxyapatite. The resin that forms the organic resin fine particles can be any resin with which an aqueous dispersion can be formed, and may be either a thermoplastic resin or a thermosetting resin. Examples thereof include a vinyl resin, a polyurethane resin, an epoxy resin, a polyester resin, a polyamide resin, a polyimide resin, a silicon resin, a phenol resin, a melamine resin, a urea resin, an aniline resin, an ionomer resin, and a polycarbonate resin. Two or more of these resins may also be used. Of these, it is preferable to use a vinyl resin, a polyurethane resin, an epoxy resin, a polyester resin, or combinations thereof because these resins will readily form an aqueous dispersion of fine, spherical resin particles.

### (Method of Dispersing Organic Resin Fine Particles in Aqueous Medium)

There are no particular restrictions on the method for making the resin into an aqueous dispersion liquid of organic resin fine particles, but the following (a) to (h) are exemplified.

(a) When the resin is a vinyl resin, an aqueous dispersion liquid of resin fine particles is directly produced by polymerization reaction (such as suspension polymerization, emulsion polymerization, seed polymerization, dispersion polymerization, or the like), using a monomer as a starting material.

(b) When the resin is a polyaddition resin or a polycondensation resin such as a polyester resin, a polyurethane resin, an epoxy resin, or the like, a precursor (such as a monomer, an oligomer or the like) or a solvent solution of the precursor is dispersed in an aqueous medium in the presence of a suitable dispersing agent, after which this dispersion is heated or cured by addition of a curing agent to thereby produce an aqueous dispersion of resin fine particles.

(c) When the resin is a polyaddition resin or a polycondensation resin such as a polyester resin, a polyurethane resin, or an epoxy resin, a suitable emulsifying agent is dissolved in a precursor (such as a monomer, an oligomer or the like) or a solvent solution of the precursor (preferably in liquid form; may be liquefied by heating), after which water is added to perform phase-inversion emulsification.

(d) A resin produced by a polymerization reaction (any polymerization reaction, such as addition polymerization, ring cleavage polymerization, polyaddition, addition condensation, condensation polymerization, and the like) is pulverized using a mechanical rotational pulverizer or a jet pulverizer, and then classified, to obtain resin fine particles, after which these are dispersed in water in the presence of a suitable dispersing agent.

(e) A resin produced by a polymerization reaction (any polymerization reaction, such as addition polymerization, ring cleavage polymerization, polyaddition, addition condensation, condensation polymerization, and the like) is dissolved in a solvent, and then the resin solution is sprayed as a mist to obtain resin fine particles, after which these are dispersed in water in the presence of a suitable dispersing agent.

(f) A resin produced by a polymerization reaction (any polymerization reaction, such as addition polymerization, ring cleavage polymerization, polyaddition, addition condensation, condensation polymerization, and the like) is dissolved in a solvent to prepare a resin solution, to which a solvent is added, or a resin solution that has been heated and dissolved in a solvent is cooled to thereby precipitate resin fine particles, and then the solvent is removed so that resin fine particles are obtained, after which these are dispersed in water in the presence of a suitable dispersing agent.

(g) A resin produced by a polymerization reaction (any polymerization reaction, such as addition polymerization, ring cleavage polymerization, polyaddition, addition condensation, condensation polymerization, and the like) is dissolved in a solvent, and then the resin solution is dispersed in an aqueous medium in the presence of a suitable dispersing agent, and this dispersion is heated, subjected to reduced pressure, etc., to remove the solvent.

(h) A resin produced by a polymerization reaction (any polymerization reaction, such as addition polymerization, ring cleavage polymerization, polyaddition, addition condensation, condensation polymerization, and the like) is dissolved in a solvent to prepare a resin solution, and then a suitable emulsifying agent is dissolved in the resin solution, after which water is added and phase-inversion emulsification is performed.

### (Surfactant)

A surfactant or the like can be used as needed to emulsify or disperse, in an aqueous medium, the oil phase which contains the toner composition. Examples of surfactants include anionic surfactants such as alkylbenzenesulfonates, α-olefin sulfonates, and phosphoric acid esters; cationic surfactants such as amine salts (such as alkyl amine salts, aminoalcohol fatty acid derivatives, polyamine fatty acid derivatives, and imidazoline), and quaternary ammonium salts (such as alkyltrimethyl ammonium salts, dialkyldimethyl ammonium salts, alkyldimethyl benzyl ammonium salts, pyridinium salts, alkyl isoquinolinium salts, and benzethonium chloride); nonionic surfactants such as fatty acid amide derivatives and polyhydric alcohol derivatives; and amphoteric surfactants such as alanine, dodecyldi(aminoethyl)glycine, di(octylaminoethyl)glycine, and N-alkyl-N,N-dimethylammonium betaine.

By using a surfactant having a fluoroalkyl group, only a small amount thereof exhibits effectiveness. Examples of anionic surfactants having a fluoroalkyl group and that can be used favorably include fluoroalkyl carboxylic acids having 2 to 10 carbon atoms and metal salts thereof, disodium perfluorooctanesulfonyl glutamate, sodium 3-[ω-fluoroalkanoyl (C6-C11)oxy]-1-alkyl(C3-C4) sulfonate, sodium 3-[ω-fluoroalkanoyl(C6-C8)-N-ethylamino-]-1-propanesulfonate, fluoroalkyl(C11-C20) carboxylic acid and metal salts thereof, perfluoroalkyl(C7-C13) carboxylic acid and metal salts thereof, perfluoroalkyl(C4-C12)sulfonic acid and metal salts thereof, perfluorooctanesulfonic acid diethanol amide, N-propyl-N-(2-hydroxyethyl)perfluorooctanesulfone amide, perfluoroalkyl(C6-C10)sulfonamide propyl trimethyl ammonium salts, perfluoroalkyl(C6-C10)-N-ethylsulfonylglycine salts, and monoperfluoroalkyl(C6-C16)ethyl phosphates. Examples of cationic surfactants include primary, secondary and tertiary amines having a fluoroalkyl group, aliphatic quaternary ammonium salts such as perfluoroalkyl(C6-C10)sulfonamide propyl trimethyl ammonium salts, benzalkonium salts, benzetonium chloride, pyridinium salts, and imidazolinium salts.

### (Protective Colloid)

It is also possible to stabilize dispersion droplets with a polymer protective colloid. Examples thereof include homopolymers and copolymers of monomers such as acids (such as acrylic acid, methacrylic acid, α-cyanoacrylic acid, α-cyanomethacrylic acid, itaconic acid, crotonic acid, fumaric acid, maleic acid, and maleic anhydride), (meth)acrylic monomers having a hydroxyl group (such as β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylic acid esters, diethylene glycol monomethacrylic acid esters, glycerol monoacrylic acid esters, glycerol monomethacrylic acid esters, N-methylolacrylamide, and N-methylolmethacrylamide), vinyl alcohol and ethers of vinyl alcohol (such as vinyl methyl ether, vinyl ethyl ether, and vinyl propyl ether), esters of vinyl alcohol and a compound having a carboxyl group (such as vinyl acetate, vinyl propionate, and vinyl butyrate), acrylamide, methacrylamide, diacetoneacrylamide, and methylol compounds thereof, acid chlorides (such as acrylic acid chloride and methacrylic acid chloride), and monomers having a nitrogen atom or a hetero ring (such as vinyl pyridine, vinyl pyrrolidone, vinyl imidazole, and ethyleneimine); compounds based on polyoxyethylene compounds (such as polyoxyethylene, polyoxypropylene, polyoxyethylene alkylamines, polyoxypropylene alkylamines, polyoxyethylene alkylamides, polyoxypropylene alkylamides, polyoxyethylene nonylphenyl ethers, polyoxyethylene lauryl phenyl ethers, polyoxyethylene stearyl phenyl esters, and polyoxyethylene nonylphenyl esters), and cellulose compounds (such as methyl cellulose, hydroxyethyl cellulose, and hydroxypropyl cellulose).

When compounds such as calcium phosphate that are soluble in acids and alkalies are used as a dispersion stabilizer, the calcium phosphate is removed from the fine particles by a method such as dissolving the calcium phosphate with an acid such as hydrochloric acid and then washing with water. The calcium phosphate can also be removed by enzymatically decomposing it. When a dispersing agent is used, the dispersing agent can be left on the toner particle surface, but it is preferably washed away, in terms of charging of the toner.

### (Dispersion Method)

There are no particular restrictions on the dispersion method, and any known dispersing machines can be used, such as low-shear dispersing machine, high-shear dispersing machine, friction dispersing machine, high-pressure jet dispersing machine, and ultrasonic dispersing machine. To adjust the particle size of the dispersion to between 2 μm and 20 μm, high-shear dispersing machine is preferable. When high-shear dispersing machine is used, there are no particular restrictions on the rotational speed, but it is usually from 1,000 rpm to 30,000 rpm, and preferably from 5,000 rpm to 20,000 rpm. The temperature during dispersion is usually from 0° C. to 150° C. (under pressure), and preferably from 20° C. to 80° C.

### (Solvent Removal)

In order to remove the organic solvent from the obtained emulsion dispersion, any known methods may be employed. For example, a method, in which the temperature of the entire system is gradually raised to completely evaporate off the organic solvent from the droplets, can be employed.

<Elongation and/or Crosslinking Reaction>

When a modified polyester resin having an isocyanate group at the terminal and an amine reactive with the isocyanate group are added in order to introduce a modified polyester resin having an urethane and/or urea group, the amine may be mixed in an oil phase before the toner composition is dispersed in an aqueous medium, or alternatively the amine may be added in the aqueous medium. The time required for completion of the reaction depends on the reactivity of the structure of the isocyanate group of the polyester prepolymer and the amine added. The time is usually 1 minute to 40 hours, preferably 1 hour to 24 hours. A reaction temperature is usually 0° C. to 150° C., preferably 20° C. to 98° C. The reaction may be conducted before the process of particle binding or during the process or after completion of the process. When necessary, a known catalyst may be used for the reaction.

### <Washing and Drying Process>

A known technique may be used for washing and drying the toner particles dispersed in the aqueous medium.

Specifically, after carrying out a solid-liquid separation using a centrifuge and a filter press, the resultant toner cake is re-dispersed in ion exchanged water having a temperature of normal temperature to about 40° C., and then if necessary, pH of the resultant dispersion liquid is regulated by an acid or an alkali, and subsequently the pH regulated dispersion liquid is subjected to solid-liquid separation again. After repeating the process a few times to remove impurities, surfactants and the like, the resultant product was dried using a flash dryer, recirculation dryer, reduced-pressure dryer, vibrating fluid dryer, or the like, to thereby yield the toner particles. Fine particle components of the toner may be removed by a centrifuge. If necessary, a particle distribution of the toner may be adjusted to a desired distribution using a known classification machine after drying.

### <External Addition>

The dried toner powder thus obtained is mixed with other particles, such as charge control fine particles or fluidizer fine particles, and the mixed powder may be subjected to mechanical impact to fix and fuse the particles at the surface, in order to prevent the other particles from falling off the surface of the composite particles thus obtained. Specific ways to accomplish this process include a method in which a mixture is subjected to an impact force by blades rotating at high speed, and a method in which a mixture is put into a high-speed gas flow and accelerated, so that the particles collide with each other, or composite particles collide with a suitable collision plate. Examples of the apparatus used for this method include HENSCHEL MIXER (produced by Mitsui Mining Co., Ltd.), SUPER MIXER (produced by Kawata Mfg. Co., Ltd.), ANGMILL (produced by Hosokawa Micron Corporation), a modified I MILL (produced by Nippon Pneumatic Mgf, Co., Ltd.) in which a lowered pulverizing air pressure is used, HYBRIDIZATION SYSTEM (produced by Nara Machinery Co., Ltd.), KRYPTON SYSTEM (produced by Kawasaki Heavy Industries, Ltd.), and automatic mortars.

### <Charging Member>

When toner adhesion is taken into account, the charging member for recharging the toner remaining on the surface of the latent electrostatic image bearing member after transfer from the latent electrostatic image bearing member to the next step is preferably conductive, as charge-up adhesion will occur if it is insulating. The surface resistance is preferably from 10² Ω/sq to 10⁸ Ω/sq, and the volumetric resistance from 10¹ Ω·cm to 10⁶ Ω·cm.

Examples of the form of the charging member include that of a roller, a brush, and a sheet, but a sheet structure is preferable in terms of the resetting of the adhered toner.

The charging member is preferably a sheet made of a material selected from nylon, PTFE, PVDF, and urethane, and from the standpoint of toner chargeability, PTFE or PVDF is more preferable.

When the charging member is a conductive sheet, a thickness of from 0.05 mm to 0.5 mm is preferable in terms of the contact pressure against the latent electrostatic image bearing member.

When the charging member is a conductive sheet, a nip width in contact with the latent electrostatic image bearing member of from 1 mm to 10 mm is preferable in terms of contact time while the toner is being charged.

In terms of charging the toner, the voltage applied to the charging member is preferably from −1.4 kV to 0 kV.

The toner is analyzed and evaluated as follows. Furthermore, the toner is evaluated as a one-component developer, but the toner of the present invention can also be used as a two-component developer by using suitable external additives and a suitable carrier.

The “kit” of the toner kit is a generic name of a combination of a color toner and a colorless transparent toner, which are mounted together in an image forming apparatus (or a developing unit). When the combination of the toners each having certain conditions is used, obtained images achieve the object of the present invention.

Therefore, the “kit” does not necessarily mean that the color toner and the colorless transparent toner are combined in a set as a product for distribution and selling.

Hereinafter, the structure of the image forming apparatus of the present invention will be described.

### (Developing Unit and Process Cartridge)

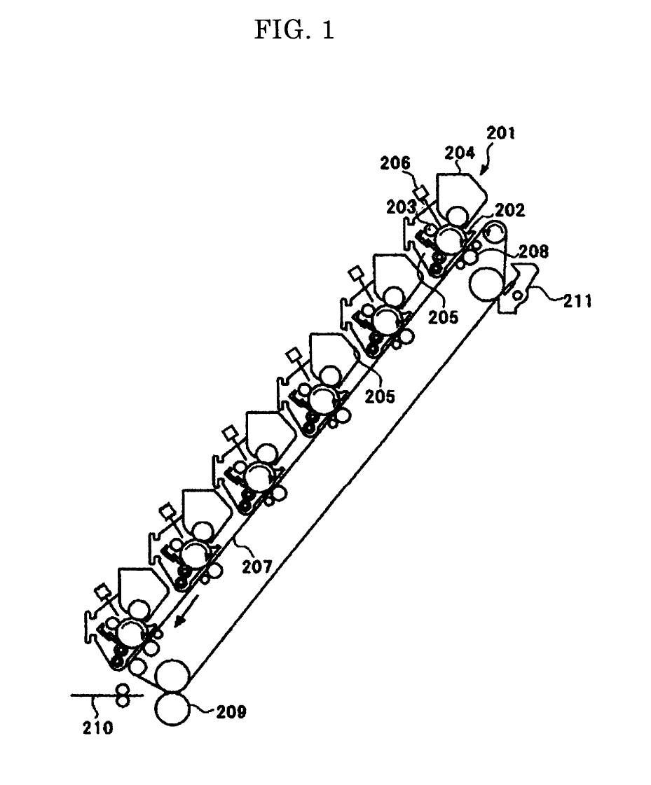

FIG. 1 shows a cross-sectional view of a main part of an image forming apparatus equipped with developing units and process cartridge units of an embodiment of the present invention.

Each process cartridge unit 201 includes a photoconductor drum 202, a charging roller 203, a developing unit 204, and a cleaning unit 205, which are integrally formed into a single unit. Each process cartridge unit 201 is configured to be replaceable by unlocking a stopper of the unit.

The photoconductor drum 202 rotates at a circumferential speed of 150 mm/sec in the direction indicated by an arrow.

The charging roller 203 presses against the surface of the photoconductor drum 202, and rotates according to the rotation of the photoconductor drum 202. A predetermined bias is applied to the charging roller 203 by a high-voltage power supply (not shown) so that the surface of the photoconductor drum 202 is charged at −500V.

An exposure unit 206 is configured to expose the photoconductor drum 202 based on image information so as to form a latent electrostatic image thereon. An LED, a laser beam scanner that uses a laser diode, or the like is used as an exposure unit 206.

The developing unit 204 is for one component contact development and configured to develop the latent electrostatic image on the photoconductor drum 202 so as to form a toner image. A predetermined developing bias is applied by a high voltage power supply (not shown) to the developing unit 204.

The photoconductor cleaning unit 205 is configured to clean residual toner on the surface of the photoconductor drum 202.

The process cartridge units 201 are tandemly arranged in the direction of movement of the intermediate transfer belt 207 and form visible images, for example, wherein the developing unit 204 located at the top of the developing units contains colorless transparent resin particles, and other four developing units 204 respectively contain toners in the following order: yellow, cyan, magenta and black. A primary transfer bias is applied to a primary transfer roller 208 and the toner image on the surface of the photoconductor drum 202 is transferred to the surface of the intermediate transfer belt 207. The intermediate transfer belt 207 is rotatably driven in the direction indicated by arrows in FIG. 1 by a drive motor (not shown), and visible images of respective colors are sequentially transferred onto a surface thereof so as to form a full color image.

The full color image that has been formed is transferred to paper 210, which is a transfer medium, by applying a predetermined voltage to the secondary transfer roller 209, and is fixed by a fixing apparatus (not shown) and output. Toner particles that failed to be transferred by the secondary transfer roller 209 and remaining on the intermediate transfer belt 207 are recovered by a transfer belt cleaning unit 211.

The developing unit used in the present invention includes a plurality of developer containers, any of which contain colorless transparent toner. The developing unit further includes a developer supply member configured to supply the developer from each of the developer containers to a surface of the developer bearing member, and the developer bearing member configured to bear the supplied developer on the surface thereof. The developer containers include a developer container containing at least the color toner and a developer container for containing at least the colorless transparent toner.

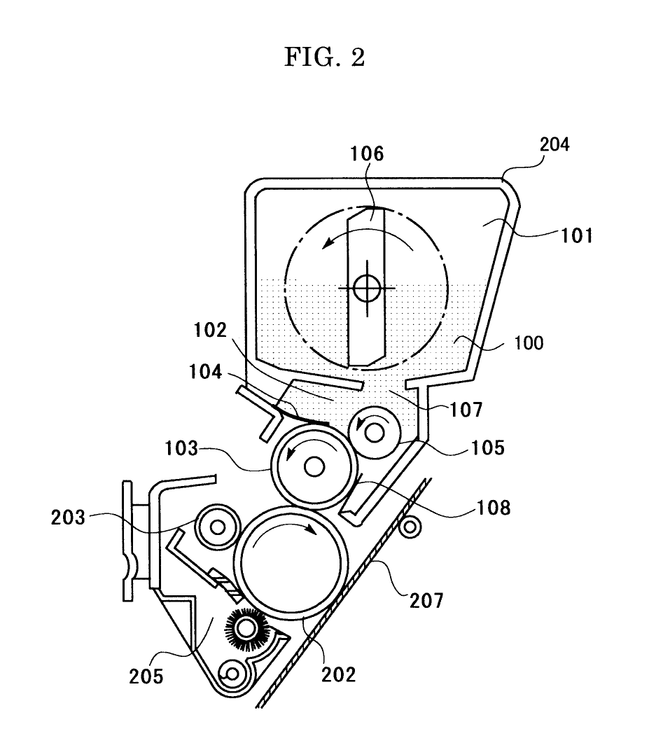

FIG. 2 shows a cross-sectional view of an example of a developing unit and process cartridge unit for an embodiment of the present invention.

The developing unit 204 contains a toner container 101 for containing toner 100, a toner supply chamber 102 disposed under the toner container 101. Under the toner supply chamber 102, a developing roller 103, and a layer thickness control unit 104 and a supply roller 105, both of which are in contact with the developing roller 103, are disposed. The developing roller 103 is disposed in contact with a photoconductor drum 202 and is applied with a predetermined developing bias by a high-voltage power supply (not shown).

In the toner container 101, a toner mixing member 106 is equipped and configured to rotate in the counterclockwise direction, so as to fluidize the contained toner, thereby accelerating the toner dropping to the toner supply chamber 102 through an opening 107. The opening 107 is provided directly above the supply roller, and only a wall partitioning the toner container 101 and the toner supply chamber 102 is provided directly above the toner layer thickness control unit 104. The surface of the supply roller 105 is coated with a foamed material having pores (cell), so that the toner fed into the toner supply chamber 102 is effectively attached and incorporated thereto, and the toner degradation by pressure concentration at a contact portion with the developing roller 103 is prevented. As the foamed material, a conductive material in which carbon fine particles are incorporated is used, and the electric resistance value of the foamed material is set at 10³Ω to 10¹³Ω. A supply bias of the value which is offset in the same direction as the charged polarity of the toner corresponding to developing bias is applied to the supply roller 105. A supply bias of the value which is offset in the same direction as the charged polarity of the toner corresponding to developing bias is applied to the supply roller 105. The supply bias affects in the direction of pressing the toner, which is precharged at the contact portion between the supply roller 105 and the developing roller 103, to the developing roller 103. The supply roller 105 rotates in the counterclockwise direction so as to supply the toner adhered on the surface thereof to the surface of the developing roller 103 to thereby coat the developing roller with the toner.

A roller coated with an elastic rubber layer is used as the developing roller 103, and a surface coat layer made of a material which is likely to be charged opposite to the polarity of the toner is further disposed on the surface of the developing roller 103. The elastic rubber layer is designed to have a hardness JIS-A of 60 degrees or less in order to keep the uniform contact with the photoconductor drum 202. Additionally, the electric resistance value of the elastic rubber layer is set at 10³Ω to 10¹⁰Ω in order to effect a developing bias. The surface roughness of the developing roller is set at Ra of 0.3 μm to 2.0 μm so that the required amount of the toner can be retained on the surface thereof. The developing roller 103 rotates in the counterclockwise direction and feeds the toner retained on the surface thereof to positions facing the toner layer thickness control unit 104 and the photoconductor drum 202.

The toner layer thickness control unit is provided lower than the position where the supply roller is contacted with the developing roller 103. The toner layer thickness control unit 104 is formed of a metallic plate spring material, such as SUS, phosphor bronze, etc. and a free end of the toner layer thickness control unit 104 is brought into contact with the surface of the developing roller 103 at a suppress strength of 10 N/m to 40 N/m. The toner passed through the suppressed spot of the toner layer thickness control unit is made in a form of thin layer and is charged by frictional charging, simultaneously. Moreover, a control bias of the value which is offset in the same direction as the charged polarity of the toner corresponding to a developing bias is applied to the toner layer thickness control unit 104 to assist frictional charging.

A material of the elastic rubber layer consisting of the surface of the developing roller is not particularly limited, and may be appropriately selected according to the purpose. Examples thereof include styrene-butadiene copolymer rubber, acrylonitrile-butadiene copolymer rubber, acrylic rubber, epichlorohydrin rubber, urethane rubber, silicone rubber, and combinations thereof. Of these, a blend rubber of epichlorohydrin rubber and acrylonitrile-butadiene copolymer rubber is preferably used.

The developing roller used in the present invention is, for example, produced by coating a periphery of conductive shaft with the above-mentioned elastic rubber material. The conductive shaft is, for example, formed of metal such as stainless steel.

The photoconductor drum 202 rotates in the clockwise direction, therefore, the surface of the developing roller 103 moves in the same direction as the moving direction of the photoconductor drum 202 at the position where the developing roller 103 faces the photoconductor drum 202.

The toner formed in the thin layer is fed to the facing position between the developing roller 103 and the photoconductor drum 202 by the rotation of the developing roller 103, and is moved to the surface of the photoconductor drum 202 and developed according to the latent image electric field formed by the developing bias applied to the developing roller 103 and a latent electrostatic image on the photoconductor drum 202.

A seal 108 is provided in contact with the developing roller 103 at the part where the toner, which has not been spent for development on the photoconductor drum 202 and remains on the developing roller 103, returns to the toner supply chamber 102 so as to seal the developing unit, and thereby prevents the toner form leaking out thereof.

The structure of the latent electrostatic image bearing member will be explained.

The charging unit used in the present invention includes a shaft, a conductive layer on the shaft, and a surface layer coated on the conductive layer, and is formed in a cylindrical shape. An electric voltage applied to the shaft by an electric source is applied to the photoconductor drum 202 via the conductive layer and the surface layer, and then charges a surface of the photoconductor drum 202.

The shaft of the charging unit is disposed along the longitudinal direction of the photoconductor drum 202 (in parallel with the axis of the photoconductor drum 202) and the charging unit is entirely pressed against the photoconductor drum 202 with a predetermined suppress strength, thereby, a portion of the surface of the photoconductor drum 202 and a portion of the surface of the charging unit are brought into contact with each other along each longitudinal direction to form a contact nip with a predetermined width. The photoconductor drum 202 is rotary driven by a driving unit (not shown) and the charging unit is configured to rotate along with the rotation of the photoconductor drum 202.

The charging of the photoconductor drum 202 by an electric source is performed at the vicinity of the above contact nip. The surface of the charging unit and a region to be charged (corresponds to the length of the charging unit) of the surface of the photoconductor drum 202 are brought into evenly contact with each other at the contact nip to thereby make the region to be charged of the surface of the photoconductor drum 202 uniformly charged.

The conductive layer of the charging unit is formed of a nonmetal, and a material of low hardness can be preferably used in order to stabilize the contact state with the photoconductor drum 202. Examples thereof include resins such as polyurethane, polyether and polyvinyl alcohol and rubbers such as hydrin rubber, EPDM and NBR. Examples of conductive materials include carbon black, graphite, titanic oxide and zinc oxide. The materials having a moderate resistance value (10²Ω to 10¹⁰Ω) are used for the surface layer. Examples of resins include nylon, polyamide, polyimide, polyurethane, polyester, silicone, TEFRON, polyacetylene, polypyrrole, polythiophene, polycarbonate and polyvinyl, and fluorine resins are preferably used for improving a water contact angle. Examples of fluorine resins include polyvinylidene-fluoride, polyethylene-fluoride, vinylidene fluoride-tetrafluoroethylene copolymer and vinylidene fluoride-tetrafluoroethylene-propylene hexafluoride copolymer.

Furthermore, conductive materials such as carbon black, graphite, titanic oxide, zinc oxide, tin oxide, iron oxide or the like may be appropriately added on the surface layer for the purpose of adjusting the resistance to moderate value.

### EXAMPLES

Hereinafter, the present invention will be explained by way of Examples, which should not be construed as limiting the present invention thereto. All part(s) and percentage (%) are by mass unless indicated otherwise.

### <Evaluation Method>

### (Gas Resistance)

Gas resistance was evaluated as follows. An application duty (Duty) was adjusted so that an optical density (O.D.) fell within the range of from 0.9 to 1.1, and then printing was performed using a full color printer IPSIO CX3000 (produced by Ricoh Company, Ltd.).

The obtained print was exposed to ozone using Ozone Weather Meter (OMS-H) (produced by Suga Test Instruments Co., Ltd.) for 3 hours under the conditions of 200 ppm ozone concentration and 24° C. and 60% RH.

The optical density of each print which had been exposed to ozone was measured using a densitometer (SPECTROLINO, produced by GretagMacbeth AG.), and remaining ratio of optical density (ROD) was obtained by the Equation 1. The measurement condition was as follows: red filter was used as a filter, a light source was D50, and a view angle was 2 degrees.

ROD (%)=(D/DO)×100 Equation 1

In Equation 1, D denotes an O.D. value after the exposure test, and D0 denotes an O.D. value before the exposure test.

Evaluation criteria were as follows:

A: ROD was 90% or more.

B: ROD was 80% or more to less than 90%.

C: ROD was 70% or more to less than 80%.

D: ROD was less than 70%.

### (Chroma)

Chroma was calculated by Equation 2 using L*a*b* color space chart.

Chroma (C*)=[(a*)2+(b*)2]/½ Equation 2

In Equation 2, a*, b* respectively denote a* coordinate value and b* coordinate value, and L* denotes a brightness coordinate.

Images were formed on a transfer medium using a toner, while the toner deposition amount was changed in a range of 0.1 mg/cm² to 1.0 mg/cm². L*a*b* space of each image was measured using a colorimeter CM-2002 (produced by KONICA MINOLTA HOLDINGS, INC.), and chroma C* was calculated by Equation 2. Then, the chroma of the image, which was evaluated as the maximum deposition amount of a dye in the evaluation of the toner deposition amount was obtained.

The evaluation criteria were as follows:

A: C* was 85 or more.

B: C* was 80 or more to less than 85.

C: C* was 75 or more to less than 8.

D: C* was less than 75.

### <Production Example of Resin>

### <Synthesis of Polyester>

### (Polyester 1)

In a reaction vessel equipped with a condenser tube, a stirrer and a nitrogen inlet tube, 553 parts of a 2 mol ethylene oxide adduct of bisphenol A, 196 parts of a 2 mol propylene oxide adduct of bisphenol A, 220 parts of terephthalic acid, 45 parts of adipic acid, and 2 parts of dibutyltinoxide were placed and reacted for 8 hours at 230° C. under normal pressure, and further reacted for 5 hours under a reduced pressure of 10 mmHg to 15 mmHg, after which 46 parts of trimellitic anhydride was added, and the mixture was reacted for 2 hours at 180° C. under normal pressure to obtain “Polyester 1.” Polyester 1 had a number-average molecular mass of 2,200, a mass-average molecular mass of 5,600, a Tg of 43° C., and an acid value of 13.

### <Synthesis of Prepolymer>

In a reaction vessel equipped with a condenser tube, a stirrer and a nitrogen inlet tube, 682 parts of a 2 mol ethylene oxide adduct of bisphenol A, 81 parts of a 2 mol propylene oxide adduct of bisphenol A, 283 parts of terephthalic acid, 22 parts of trimellitic anhydride, and 2 parts of dibutyltin oxide were placed and reacted for 8 hours at 230° C. under normal pressure, and further reacted for 5 hours under a reduced pressure of 10 mmHg to 15 mmHg to obtain “Intermediate Polyester 1.” Intermediate Polyester 1 had a number-average molecular mass of 2,100, a mass-average molecular mass of 9,500, a Tg of 55° C., an acid value of 0.5, and a hydroxyl value of 49.

Next, in a reaction vessel equipped with a condenser tube, a stirrer and a nitrogen inlet tube, 411 parts of Intermediate Polyester 1, 89 parts of isophorone diisocyanate, and 500 parts of ethyl acetate were placed and reacted for 5 hours at 100° C. to obtain “Prepolymer 1.” Prepolymer 1 had a free isocyanate content of 1.53%.

### <Production of Master Batch>

In a HENSCHEL MIXER, 40 parts of Carbon black (REGAL 400R, produced by Cabot Corporation), 60 parts of a binder resin (RS-801, a polyester resin, produced by Sanyo Chemical Industries, Ltd.; acid value of 10, Mw of 20,000, Tg of 64° C.), and 30 parts of water were mixed to obtain a mixture in which a pigment aggregate was impregnated with water. The resultant mixture was kneaded for 45 minutes in a two-roll kneader with the roll surface temperature set at 130° C., and the kneaded product was pulverized to a size of 1 mm in diameter using a pulverizer, to thereby obtain “Master Batch 1.”

### <Production Example of Colorless Transparent Toner 1>

### <Production of Wax Dispersion Liquid (Oil Phase)>

In a vessel equipped with a stirrer and a thermometer, 378 parts of Polyester 1, 120 parts of paraffin wax (HNP9), 96 parts of a releasing agent (WAX) dispersing agent (styrene-polyethylene polymer having a Tg 73° C. and a number average molecular mass of 7,100) (a ratio of releasing agent: 80%), and 1,450 parts of ethyl acetate were placed, and the mixture was raised in temperature to 80° C. under stirring, the temperature was held at 80° C. for 5 hours, and then the resultant mixture was cooled to 30° C. in 1 hour. Then, 500 parts of ethyl acetate was placed in the vessel and mixed for 1 hour to obtain “Raw Material Solution 1.”

To the vessel, 1,500 parts of Raw Material Solution 1 was transferred, and carbon black and the wax were dispersed by using a bead mill (ULTRAVISCOMILL, produced by Imex Co., Ltd.) filled with zirconia beads having a diameter of 0.5 mm at a filling ratio of 80% by volume under the conditions of three passes, a liquid feed rate of 1 kg/hr and a disk peripheral speed of 6 m/sec. Then, 655 parts of a 65% ethyl acetate solution of Polyester 1 was added, and the resultant mixture was dispersed one time using the bead mill under the above conditions to obtain “Wax Dispersion Liquid 1.” Ethyl acetate was added to the Wax Dispersion Liquid 1 so as to have a solid content of 50% (at 130° C., for 30 minutes).

### <Preparation of Aqueous Phase>

In 953 parts of ion exchanged water, 88 parts of a 25% aqueous dispersion liquid of organic resin fine particles (a copolymer of styrene-methacrylic acid-butyl acrylate-sodium salt of sulfuric acid ester of ethylene oxide adduct of methacrylic acid) used as a dispersion stabilizer, 80 parts of a 48.5% aqueous solution of sodium dodecyldiphenyl ether disulfonate (ELEMINOL MON-7, produced by Sanyo Chemical Industries Ltd.), and 113 parts of ethyl acetate were mixed and stirred to obtain a milky white liquid. This was termed “Aqueous Phase 1.”

### <Emulsifying Step>

In a vessel, 967 parts of Wax Dispersion Liquid 1, 5% (a toner solid content basis) of CLAYTON APA (produced by Southern Clay Products, Inc.), and 6 parts of isophorone diamine as amine were placed and mixed for 1 minute at 5,000 rpm by a TK HOMOMIXER (produced by Primix Corporation), after which 137 parts of Prepolymer 1 was added and mixed for 1 minute at 5,000 rpm by the TK HOMOMIXER, and 1,200 parts of Aqueous Phase 1 was added and mixed for 20 minutes at 8,000 rpm to 13,000 rpm by the TK HOMOMIXER to obtain “Emulsified Slurry 1”.

### <Solvent Removal>

Emulsified slurry 1 was poured into a vessel equipped with a stirrer and a thermometer, and solvent removal was performed for 8 hours at 30° C. to obtain “Dispersion Slurry 1.”

### <Washing and Drying>

Dispersion Slurry 1 (100 parts) was filtered under reduced pressure, and then the following steps were carried out.

(1) To a filter cake, 100 parts of ion exchanged water was added and mixed by a TK HOMOMIXER (for 10 minutes at 12,000 rpm, and the mixture was then filtered.

(2) 900 parts of ion exchanged water was added to the filter cake obtained in (1) and ultrasonic vibration was applied to the filter cake and the filter cake was mixed by the TK HOMOMIXER (for 30 minutes at 12,000 rpm), and then the mixture was filtered under reduced pressure. This operation was repeated so that the electrical conductivity of the reslurry was 10 μC/cm or less.

(3) 10% hydrochloric acid was added to adjust the pH of the reslurry obtained in (2) to 4, and the mixture was stirred with a three-one motor, and then 30 minutes later the mixture was filtered.

(4) 100 parts of ion exchanged water was added to the filter cake obtained in (3), and the filter cake was mixed by the TK HOMOMIXER (for 10 minutes at 12,000 rpm), and then the mixture was filtered. This operation was repeated so that the electrical conductivity of the reslurry was 10 μC/cm or less, to thereby obtain “Filter Cake 1.”

Filter cake 1 was dried for 48 hours at 45° C. in a circular air drier and then sieved through a 75 μm mesh sieve to obtain “Toner Base 1.” Toner Base 1 had a volume average particle diameter (Dv) of 5.8 μm, a number average particle diameter (Dp) of 5.2 μm, Dv/Dp of 1.12, an average circularity of 0.973, and an ATR value of 0.04. Then, to 100 parts of Toner Base 1, 1.5 parts of a hydrophobic silica H2000/4 (a particle diameter of 12 nm, produced by Clariant) and 0.5 parts of a hydrophobic silica RX50 (a particle diameter of 40 nm, produced by Nippon Aerosil) were added and mixed by using a HENSCHEL mixer, to thereby obtain “Colorless Transparent Toner 1” of the present invention.

### (Production Examples of Colorless Transparent Toners 2 to 4)

Each of Colorless Transparent Toners 2 to 4 was produced in the same manner as in Production Example of Colorless Transparent Toner 1, except that the amount of the CLAYTON APA was changed from 5% (a toner solid content basis) (produced by Southern Clay Products) to those shown in Table 1.

TABLE 1

| | Amount of CLAYTON APA | Remarks |
|---|---|---|
| Colorless Transparent Toner 1 | 5% | |
| Colorless Transparent Toner 2 | 0% | |
| Colorless Transparent Toner 3 | 18% | |
| Colorless Transparent Toner 4 | 0.1% | |
| Colorless Transparent Toner 5 | 5% | pulverized |
| Colorless Transparent Toner 6 | 0% | pulverized |

### <Production Example of Black Toner 1>

### <Production of Pigment/Wax Dispersion Liquid (Oil Phase)>

In a vessel equipped with a stirrer and a thermometer, 378 parts of Polyester 1, 120 parts of paraffin wax (HNP9), 96 parts of a releasing agent (WAX) dispersing agent (styrene-polyethylene polymer having a Tg 73° C. and a number average molecular mass of 7,100) (a ratio of releasing agent: 80%), and 1,450 parts of ethyl acetate were placed, and the mixture was raised in temperature to 80° C. under stirring, the temperature was held at 80° C. for 5 hours, and then the resultant mixture was cooled to 30° C. in 1 hour. Then, 500 parts of “Master Batch 1” and 500 parts of ethyl acetate were placed in the vessel and mixed for 1 hour to obtain “Raw Material Solution 2.”

To the vessel, 1,500 parts of Raw Material Solution 2 was transferred, and the carbon black and the wax were dispersed by using a bead mill (ULTRAVISCOMILL, produced by Imex Co., Ltd.) filled with zirconia beads having a diameter of 0.5 mm at a filling ratio of 80% by volume under the conditions of three passes, a liquid feed rate of 1 kg/hr and a disk peripheral speed of 6 m/sec. Then, 655 parts of a 65% ethyl acetate solution of Polyester 1 was added, and the resultant mixture was passed one time using the bead mill under the above conditions to obtain “Pigment/Wax Dispersion Liquid 1.” Ethyl acetate was added to the Pigment/Wax Dispersion Liquid 1 so as to have a solid content of 50% (at 130° C., for 30 minutes).

### <Preparation of Aqueous Phase>

In 953 parts of ion exchanged water, 88 parts of a 25% aqueous dispersion liquid of organic resin fine particles (a copolymer of styrene-methacrylic acid-butyl acrylate-sodium salt of sulfuric acid ester of ethylene oxide adduct of methacrylic acid) used as a dispersion stabilizer, 80 parts of a 48.5% aqueous solution of sodium dodecyldiphenyl ether disulfonate (ELEMINOL MON-7, produced by Sanyo Chemical Industries Ltd.), and 113 parts of ethyl acetate were mixed and stirred to obtain a milky white liquid. This was termed “Aqueous Phase 1.”

### <Emulsifying Step>

In a vessel, 967 parts of Pigment/Wax Dispersion Liquid 1, 5% (a toner solid content basis) of CLAYTON APA (produced by Southern Clay Products, Inc.), and 6 parts of isophorone diamine as amine were placed and mixed for 1 minute at 5,000 rpm by a TK HOMOMIXER (produced by Primix Corporation), after which 137 parts of Prepolymer 1 was added and mixed for 1 minute at 5,000 rpm by a TK HOMOMIXER, and 1,200 parts of Aqueous Phase 1 was added and mixed for 20 minutes at 8,000 to 13,000 rpm by the TK HOMOMIXER to obtain “Emulsified Slurry 2”.

### <Solvent Removal>

Emulsified slurry 2 was poured into a vessel equipped with a stirrer and a thermometer, and solvent removal was performed for 8 hours at 30° C. to obtain “Dispersion Slurry 2.”

### <Washing and Drying>

Dispersion Slurry 2 (100 parts) was filtered under reduced pressure, and then the following steps were carried out.

(1) To the filter cake, 100 parts of ion exchanged water was added and mixed by a TK HOMOMIXER (for 10 minutes at 12,000 rpm, and the mixture was then filtered.

(2) 900 parts of ion exchanged water was added to the filter cake obtained in (1) and ultrasonic vibration was applied to the filter cake and the filter cake was mixed by the TK HOMOMIXER (for 30 minutes at 12,000 rpm), and then the mixture was filtered under reduced pressure. This operation was repeated so that the electrical conductivity of the reslurry was 10 μC/cm or less.

(3) 10% hydrochloric acid was added to adjust the pH of the reslurry obtained in (2) to 4, and the mixture was stirred with a three-one motor, and then 30 minutes later the mixture was filtered.

(4) 100 parts of ion exchanged water was added to the filter cake obtained in (3), and the filter cake was mixed by the TK HOMOMIXER (for 10 minutes at 12,000 rpm), and then the mixture was filtered. This operation was repeated so that the electrical conductivity of the reslurry was 10 μC/cm or less, to thereby obtain “Filter Cake 2.”

Filter Cake 2 was dried for 48 hours at 45° C. in a circular air drier and then sieved through a 75 μm mesh sieve to obtain “Toner Base 2.” Toner Base 2 had a volume average particle diameter (Dv) of 5.8 μm, a number average particle diameter (Dp) of 5.2 μm, Dv/Dp of 1.12, an average circularity of 0.973, and an ATR value of 0.04. Then, to 100 parts of Toner Base 2, 1.5 parts of a hydrophobic silica H2000/4 (a particle diameter of 12 nm, produced by Clariant) and 0.5 parts of a hydrophobic silica RX50 (a particle diameter of 40 nm, produced by Nippon Aerosil) were added and mixed by using a HENSCHEL mixer, to thereby obtain “Black Toner 1” of the present invention.

### <Production Example of Magenta Toner 1>

Magenta Toner 1 was produced in the same manner as in Black Toner 1, except that the carbon black of Black Toner 1 was changed to Solvent Red 49 (oil-soluble dye, Oil Pink 312, produced by ORIENT CHEMICAL INDUSTRIES CO., LTD.).

### <Production Example of Magenta Toner 2>

Magenta Toner 2 was produced in the same manner as in Magenta Toner 1, except that CLAYTON APA was not added.

### <Production Example of Cyan Toner 1>

Cyan Toner 1 was produced in the same manner as in Black Toner 1, except that the carbon black of Black Toner 1 was changed to 15 parts of Solvent Blue 70 (oil-soluble dye, Oleosol Fast Blue ELN, produced by Taoka Chemical Co., Ltd.).

### <Production Example of Yellow Toner 1>

Yellow Toner 1 was produced in the same manner as in Black Toner 1, except that the carbon black of the Black Toner 1 was changed to 15 parts of Disperse Yellow 160 (disperse dye, Plast Yellow 8050, produced by ARIMOTO CHEMICAL Co., Ltd.).

### <Production Example of Colorless Transparent Toner 5>

### (Production of First Binder Resin A1)

In a 5 liter four-necked flask equipped with a thermometer, a stainless stirrer, a falling type condenser and a nitrogen introducing tube, 2,210 g of polyoxypropylene (2.2)-2,2-bis(4-hydroxyphenyl)propane as polyol, 850 g of terephthalic acid, 120 g of anhydrous 1,2,4-benzenetricarboxylic acid anhydride and 0.5 g of dibutyl tin oxide as an esterification catalyst were placed. Then, under the nitrogen atmosphere in a mantle heater, the temperature was raised to 230° C. and the polycondensation reaction was performed. The polymerization degree was traced by means of a softening point measured using a constant load extrusion capillary rheometer, and upon reaching a desired softening point, the reaction was terminated to obtain a resin A1.

The resin A1 had a number average molecular mass of 3,502, a mass average molecular mass of 13,756, a glass transition temperature of 64.6° C., and a softening temperature of 115° C.

### (Preparation of Second Binder Resin B1)

In a 5 liter four-necked flask equipped with a thermometer, a stainless stirrer, a falling type condenser and a nitrogen introducing tube, 1,230 g of polyoxypropylene (2.2)-2,2-bis(4-hydroxyphenyl) propane, 290 g of polyoxyethylene (2.2)-2,2-bis(4-hydroxyphenyl) propane as polyol, 250 g of isododecenyl succinic acid anhydride, 310 g of terephthalic acid, 180 g of 1,2,4-benzene tricarboxylic acid anhydride, 7 g of dibutyl tin oxide as an esterification catalyst were placed, and subsequently, under a nitrogen atmosphere in a mantle heater, the temperature was raised to 230° C. and a polycondensation reaction was performed. The polymerization degree was traced by means of a softening point measured using a constant load extrusion capillary rheometer, and upon reaching a desired softening point, the reaction was terminated to obtain a resin B1. The resin B1 had a number average molecular mass of 2,778, a mass average molecular mass of 57,640, a glass transition temperature of 65.0° C., and a softening temperature of 138° C.

### (Production of Toner Particles)

### (1—Premixing)

The first binder resin A1 (60 parts), 40 parts of the second binder resin B1, 5% (a toner solid content basis) of CLAYTON APA (produced by Southern Clay Products) and 4.0 parts of WEP-5 (produced by NOF Corporation) as a releasing agent were sufficiently mixed by using a HENSCHEL mixer.

### (2—Kneading)

Melt-kneading of the premix using a stone mortar kneader (korokudo mill) was performed under the conditions as follows: feeding amount: 95 kg/h, a screw revolution: 85 rpm and controlled temperatures: 10° C. at a feeding portion (F), 125° C. at barrel portions (K1-K4), and 100° C. at a vent portion (V) and a dice portion (D). The obtained kneaded product was rolled with a cooling press roller to a thickness of 2 mm, and the pressed product was cooled down by a cooling belt, and roughly pulverized by a feather mill.

### (3-Pulverizing, Classification and External Addition)

Then, the roughly pulverized product was further pulverized to an average particle size of 10 μm to 12 μm using a mechanical pulverizer (KTM, produced by Kawasaki Heavy Industries, Ltd.), followed by pulverizing with a jet pulverizer (IDS, produced by Nippon Pneumatic Mfg. Co., Ltd.), and removing rough particles. Fine particles were then classified using a rotor classifier (classifier type, 100ATP, produced by Hosokawa Micron Corporation), to thereby yield coloring resin particles 1 having a volume average particle diameter of 9.0 μm. A desired amount (parts by mass) of CAB-O-SIL TS530 (produced by Cabot Corporation) was added to 100 parts by mass of the coloring resin particles 1, and mixed by using a HENSCHEL mixer, to thereby obtain a Colorless Transparent Toner 5.

### <Production Example of Colorless Transparent Toner 6>

Colorless Transparent Toner 6 was obtained in the same manner as in Colorless Transparent Toner 5, except that CLAYTON APA was not added in (1—Premixing) of the method for producing Colorless Transparent Toner 5.

### Example 1

In IPSIO CX3000 (produced by Ricoh Company, Ltd.), in a developing unit for magenta toner, a two component developer produced by mixing and stirring 5 parts of Magenta Toner 1 and 95 parts of a silicone resin coated carrier was charged, in a developing unit for yellow toner and a developing unit for black toner, a two component developer produced by mixing and stirring 5 parts of Colorless Transparent Toner 1 and 95 parts of a silicone resin coated carrier was charged, and in a developing unit for cyan toner no toner was charged. Images were printed on transfer media (TYPE 6200Y, produced by Ricoh Company, Ltd.) using the IPSIO CX3000, and the images were evaluated. The evaluation results are shown in Table 2.

### Examples 2 to 11 and Comparative Examples 1 to 4

Each image of Examples 2 to 11 and Comparative Examples 1 to 4 was evaluated in the same manner as in Example 1, except that the developing unit, toner, and printing paper were changed to those shown in Table 2. The evaluation results are shown in Table 2.

TABLE 2

| | | | | | | | Gas | |
|---|---|---|---|---|---|---|---|---|
| | Position of cartridge | | | | Transfer | | barrier | |
| | Y | M | C | K | medium | Chroma | property | Remarks |
| Ex. 1 | Colorless Transparent | Magenta Toner 1 | empty | Colorless Transparent | plain paper | B | A | standard |
| | Toner 1 | | | Toner 1 | | | | |
| Ex. 2 | Colorless Transparent | Yellow Toner 1 | empty | Colorless Transparent | plain paper | B | A | |
| | Toner 1 | | | Toner 1 | | | | |
| Ex. 3 | Colorless Transparent | Cyan Toner 1 | empty | Colorless Transparent | plain paper | B | A | |
| | Toner 1 | | | Toner 1 | | | | |
| Ex. 4 | Colorless Transparent | Black Toner 1 | empty | Colorless Transparent | plain paper | B | A | |
| | Toner 1 | | | Toner 1 | | | | |
| Ex. 5 | Colorless Transparent | Magenta Toner 1 | empty | empty | plain paper | B | C | single side |
| | Toner 1 | | | | | | | |
| Ex. 6 | Colorless Transparent | Magenta Toner 1 | Yellow | Colorless Transparent | plain paper | B | A | two colors |
| | Toner 1 | | Toner 1 | Toner 1 | | | | |
| Ex. 7 | Colorless Transparent | Magenta Toner 2 | empty | Colorless Transparent | plain paper | B | B | color toner contained no |
| | Toner 1 | | | Toner 1 | | | | APA |
| Ex. 8 | Colorless Transparent | Magenta Toner 1 | empty | Colorless Transparent | plain paper | C | B | maximum amount of |
| | Toner 3 | | | Toner 3 | | | | APA |
| Ex. 9 | Colorless Transparent | Magenta Toner 1 | empty | Colorless Transparent | plain paper | B | C | minimum amount of |
| | Toner 4 | | | Toner 4 | | | | APA |
| Ex. 10 | Colorless Transparent | Magenta Toner 1 | empty | empty | coated paper | B | B | Transparent single side/ |
| | Toner 1 | | | | | | | coated paper |
| Comp. Ex. 1 | Colorless Transparent | Magenta Toner 1 | empty | empty | coated paper | B | D | Transparent single side/ |
| | Toner 2 | | | | | | | plain paper |
| Comp. Ex. 2 | Colorless Transparent | Magenta Toner 1 | empty | Colorless Transparent | plain paper | B | D | Transparent toner |
| | Toner 2 | | | Toner 2 | | | | contained no APA |
| Comp. Ex. 3 | Colorless Transparent | Magenta Toner 2 | empty | Colorless Transparent | plain paper | B | D | Transparent toner |
| | Toner 2 | | | Toner 2 | | | | contained no APA, color |
| | | | | | | | | toner contained no APA |
| Ex. 11 | Colorless Transparent | Magenta Toner 1 | empty | Colorless Transparent | plain paper | B | B | pulverized contained |
| | Toner 5 | | | Toner 1 | | | | APA |
| Comp. Ex. 4 | Colorless Transparent | Magenta Toner 1 | empty | Colorless Transparent | plain paper | B | D | pulverized no APA |
| | Toner 6 | | | Toner 1 | | | | |

Coated paper: Ricoh Business Coat Gloss 100
Plain paper: Type6200Y
APA denotes CLAYTON APA

The toners contained in cartridges were used for developing in the order of Y, M, C, and K, and over an intermediate transfer medium, a toner image formed using the toner contained in the cartridge K was located at the top, and a toner image formed using the toner contained in the cartridge Y was located at the bottom of the toner images. The toner images superimposed over the intermediate transfer medium were transferred to a recording medium. Finally, over paper (the recording medium), the toner image formed using the toner contained in the cartridge K was located at the bottom, and the toner image formed using the toner contained in the cartridge Y was located at the top of the layers of the toner image.

What is claimed is:

1. A colorless transparent toner comprising:
a binder resin; and
a layered inorganic mineral,
wherein the layered inorganic mineral is an organic modified layered inorganic mineral, in which at least part of ions present between layers are modified with an organic ion.

2. The colorless transparent toner according to claim 1, wherein the amount of the layered inorganic mineral is 0.01% by mass to 20% by mass.

3. A toner kit comprising:
a color toner; and
the colorless transparent toner according to claim 1,
wherein the color toner comprises a binder resin and a colorant.

4. The toner kit according to claim 3, wherein the colorant of the color toner is a dye.

5. An image forming apparatus comprising:
a plurality of toner image forming units configured to form an image of a color toner and an image of a colorless transparent toner on a recording medium; and
a fixing unit configured to fix the toner images on the recording medium,
wherein each of the toner image forming units comprises:
a latent image bearing member,
a charging unit configured to uniformly charge a surface of the latent image bearing member,
an exposing unit configured to expose the charged surface of the latent image bearing member based on image data so as to form a latent electrostatic image thereon,
a developing unit configured to develop the latent electrostatic image formed on the surface of the latent image bearing member with supplying a developer using a toner kit so as to form a visible image, and
a transferring unit configured to transfer the visible image on the surface of the latent image bearing member to the recording medium,
wherein each of the developing units comprises:
a developer container for containing the developer,
a developer supply member configured to supply the developer from the developer container to a surface of a developer bearing member, and
the developer bearing member configured to bear the supplied developer,
wherein at least one of the developing units contains the developer containing the color toner, and at least one of the developing unit contains the developer containing the colorless transparent toner,
wherein the color toner and the colorless transparent toner are contained in the toner kit according to claim 3.

6. An image forming method comprising:
forming an image of a color toner and an image of a colorless transparent toner on a recording medium using the toner kit according to claim 3, and
fixing the toner images on the recording medium.
